(19) United States
(12) Patent Application Publication
(10) Pub. No.: US 2010/0131190 A1
(43) Pub. Date: May 27, 2010

(54) NAVIGATION APPARATUS

(75) Inventors: Akira Terauchi, Wako-shi (JP); Yosuke Fuchiwaki, Wako-shi (JP); Yoshitaka Mimura, Wako-shi (JP); Ryosuke Tanaka, Wako-shi (JP); Nobuko Hashikawa, Wako-shi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD., Tokyo (JP)

(21) Appl. No.: 12/622,810

(22) Filed: Nov. 20, 2009

(30) Foreign Application Priority Data
Nov. 26, 2008 (JP) 2008-300744

(51) Int. Cl. G01C 21/36

(52) U.S. Cl. 701/201

(57) ABSTRACT

A navigation apparatus of a vehicle having a monitor displaying a routing path from a current location to a designated destination on a map, and an auxiliary display installed independently of the monitor at a position closer than the monitor to a lower edge of a windshield. In the apparatus, the auxiliary display is operated to display a first bent arrow of prescribed length indicating that an intersection to turn is a first predetermined distance away from the current location when a calculated distance becomes equal to the first predetermined distance, and a second bent arrow of a length shorter than the prescribed length indicating that the intersection approaches closer when the distance becomes equal to a second predetermined distance defined shorter than the first predetermined distance, thereby enabling to provide sure visual route guidance to driver.

### BACKGROUND OF THE INVENTION

1. Field of the Invention

This invention relates to a navigation apparatus, more particularly to an apparatus which suitably guides a vehicle driver when navigating an intersection.

2. Description of the Related Art

Japanese Laid-Open Patent Application No. 2005-172564 teaches a known navigation apparatus which comprises current location detection means for detecting the current location of the vehicle equipped with the apparatus, routing path calculating means for calculating a routing path from the current location to a destination designated by the driver, a monitor for displaying the routing path on a map, and an auxiliary display (portable information terminal) provided separately of the monitor for simple display by use of arrows of branch directions different from what is displayed on the monitor.

### SUMMARY OF THE INVENTION

The navigation apparatus taught by the reference is configured to use arrows to display branch directions simply so as to provide visual route guidance even when the driver cannot spare the time to view the road map on the monitor, but the simplicity of the display proportionally increases the risk of a misunderstanding that might, for example, lead the driver to turn too early. Also, although the reference states that the auxiliary display is situated for easy viewing by the vehicle driver, no details are given.

The object of this invention is therefore to overcome the aforesaid drawbacks by providing a navigation apparatus that uses arrows to display intersections on an auxiliary display simply and in stages, and disposes the auxiliary display at location where the driver can view it more easily than a monitor, thereby enabling to provide sure visual route guidance to driver.

In order to achieve the object, this invention provides in its first aspect a navigation apparatus of a vehicle, comprising: a current location detector that detects a current location of the vehicle; a routing path calculator that calculates a routing path from the current location to a designated destination; a monitor adapted to display the calculated routing path on a map; an auxiliary display that is installed independently of the monitor and positioned closer than the monitor to a lower edge of a windshield of the vehicle; a distance calculator that calculates a distance along the routing path from the current location to an intersection in a direction of the designated destination at which the vehicle is to turn; and an auxiliary display operator that operates the auxiliary display to display a first bent arrow of prescribed length which indicates that the intersection is a first predetermined distance away from the current location when the calculated distance has become equal to the first predetermined distance, and a second bent arrow of a length that is shorter than the prescribed length which indicates that the intersection approaches closer when the distance has become equal to a second predetermined distance that is defined shorter than the first predetermined distance.

In order to achieve the object, this invention provides in its second aspect a navigation method of a vehicle having a monitor and an auxiliary display that is installed independently of the monitor and positioned closer than the monitor to a lower edge of a windshield of the vehicle, comprising the steps of: detecting a current location of the vehicle; calculating a routing path from the current location to a designated destination and displaying the calculated routing path on a map on the monitor; calculating a distance along the routing path from the current location to an intersection in a direction of the designated destination at which the vehicle is to turn; and operating the auxiliary display to display a first bent arrow of prescribed length which indicates that the intersection is a first predetermined distance away from the current location when the calculated distance has become equal to the first predetermined distance, and a second bent arrow of a length that is shorter than the prescribed length which indicates that the intersection approaches closer when the distance has become equal to a second predetermined distance that is defined shorter than the first predetermined distance.

### BRIEF DESCRIPTION OF THE DRAWINGS

The above and other objects and advantages of the invention will be more apparent from the following description and drawings in which:

FIG. 1 is a schematic diagram showing the overall configuration of a navigation apparatus according to an embodiment of this invention;

FIG. 2 is a front view in the vicinity of a dashboard of a vehicle equipped with the apparatus shown in FIG. 1;

FIG. 3 is an explanatory view showing a screen of a monitor shown in FIG. 1;

FIG. 4 is a flowchart showing the sequence of operations of the apparatus shown in FIG. 1;

FIG. 5 is a set of explanatory views for explaining the processing of the flowchart of FIG. 4;

FIG. 6 is a set of explanatory views similarly explaining the processing of the flowchart of FIG. 4; and

FIG. 7 is an enlarged explanatory view showing an alternative example of a first arrow shown in FIG. 5.

### DETAILED DESCRIPTION OF THE PREFERRED EMBODIMENT

A preferred embodiment for implementing the navigation apparatus according to this invention is explained in the following with reference to the attached drawings.

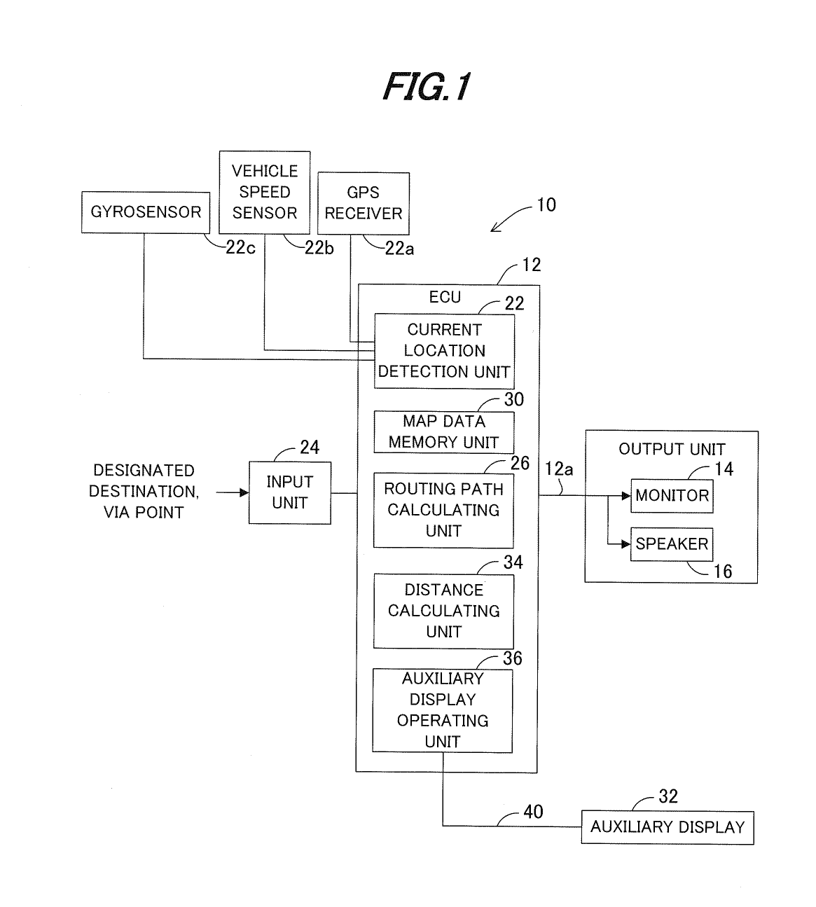

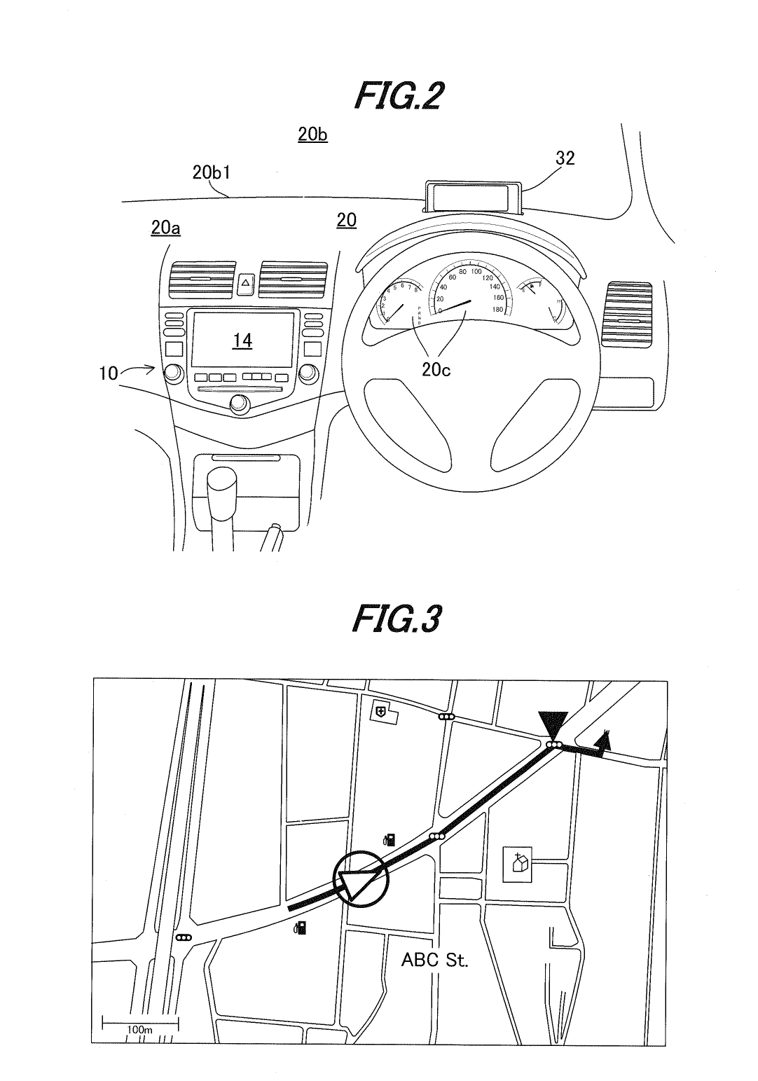

FIG. 1 is a schematic diagram showing the overall configuration of the navigation apparatus according to an embodiment of this invention. FIG. 2 is a front view in the vicinity of the dashboard of the vehicle equipped with the navigation apparatus.

In FIG. 1, the navigation apparatus is designated by the reference numeral 10. The navigation apparatus 10 is equipped with an ECU (Electronic Control Unit) 12, monitor 14 and speaker 16. As shown in FIG. 2, the navigation apparatus 10 is housed in a dashboard 20a of a vehicle 20.

The ECU 12, which comprises a microcomputer having a CPU, ROM, RAM and I/O ports, is equipped with a current location detection unit (current location detector) 22 for detecting the current location of the vehicle 20 in which the navigation apparatus 10 is installed and a routing path calculating unit (routing path calculator) 26 for calculating a routing path from the detected current location to a designated destination (or via point) that is designated by an input operation of the driver through an input unit 24 comprising a switch.

The current location detection unit 22 is equipped with a GPS receiver 22a for receiving GPS (Global Positioning System) signals, a vehicle speed sensor 22b that produces an output or signal proportional to the traveling speed (vehicle speed) of the vehicle 20, and a gyrosensor 22c that produces an output or signal proportional to the rotational angular velocity (yaw rate) about the vertical center axis of the vehicle 20. The current location detection unit 22 detects the current location, i.e., the place where the vehicle 20 is presently positioned (traveling), from the received GPS signals and the outputs of the gyrosensor 22c, etc.

As shown in FIG. 3, the monitor 14 displays the calculated routing path on a map stored in a map data memory unit 30. The map data memory unit 30 stores map data and the like including road data used for displaying the map on the monitor 14.

The routing path calculating unit 26 performs map matching with respect to the road data acquired from the map data memory unit 30 based on the current location detected by the current location detection unit 22 and calculates a routing path to the destination by performing route retrieval, route guidance and other processing with respect to the designated destination.

The navigation apparatus 10 is further equipped with an auxiliary display 32 that is installed independently of the monitor 14 and positioned closer than the monitor 14 to the lower edge 20b1 of the windshield 20b of the vehicle 20, a distance calculating unit (distance calculator) 34 for calculating the distance D along the routing path from the current location to an intersection in the direction of the designated destination at which the vehicle 20 is to turn, and an auxiliary display operating unit (auxiliary display operator) 36.

As shown in FIG. 2, the auxiliary display 32 is installed on top of the dashboard 20a to be located closer than the monitor 14 to the lower edge 20b1 of the windshield 20b of the vehicle 20.

More specifically, the auxiliary display 32 is a head-up display (HUD) that uses a flat mirror and (retractable) concave mirror to project a liquid crystal display (LCD) screen onto the windshield 20b as a virtual image.

In the navigation apparatus 10, the ECU 12 is connected to the monitor 14 and speaker 16 by a signal line 12a, and the auxiliary display operating unit 36 and auxiliary display 32 are connected by a controller area network (CAN) or other such communication system 40. The auxiliary display operating unit 36 of the navigation apparatus 10 transmits codes representing first to third arrows and other screen elements to the auxiliary display 32 for display thereon.

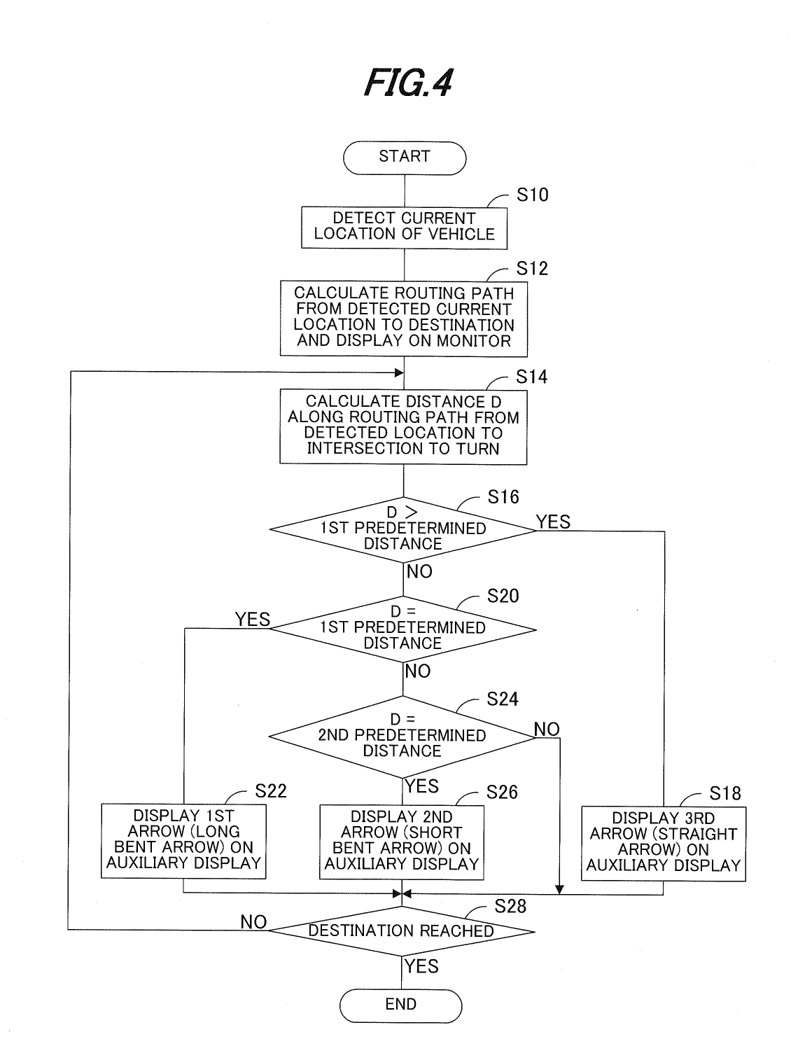

FIG. 4 is a flowchart showing the sequence of operations of the navigation apparatus 10, specifically of the current location detection unit 22, routing path calculating unit 26 and auxiliary display operating unit 36. The ECU 12 repeatedly executes the illustrated program at regular intervals.

First, in S10, the current location of the vehicle 20 is detected (measured), whereafter the program proceeds to S12, in which a routing path from the detected current location to the designated destination is calculated and displayed on the monitor 14. Next, in S14, the distance D along the calculated routing path from the detected current location to an intersection (in the direction of the designated destination) where the vehicle 20 is to turn is calculated.

Next, in S16, it is determined whether the calculated distance D is greater than a first predetermined distance (e.g., 700 meters). When the result in S16 is YES, the program proceeds to S18, in which a straight arrow (straight third arrow) is displayed on the auxiliary display 32.

When the result in S16 is NO, i.e., when it is determined that the distance D does not exceed the first predetermined distance, the program proceeds to S20, in which it is determined whether the distance D has become equal to the first predetermined distance, more exactly whether the distance D has become precisely or substantially equal to the first prescribed distance. When the result in S20 is YES, the program proceeds to S22, in which a first bent arrow (right-turn arrow) of prescribed length (long bent arrow), which indicates that the intersection to turn to right (as suggested by the direction of bent) is the first predetermined distance (e.g., 700 meters) away, is displayed on the auxiliary display 32.

When the result in S20 is NO, the program proceeds to S24, in which it is determined whether the distance D has become equal to a second predetermined distance, more exactly whether the distance D has become precisely or substantially equal to the second predetermined distance. The second predetermined distance is defined shorter than the first predetermined distance (e.g., 700 meters), namely is defined as 300 meters, for example.

When the result in S24 is YES, i.e., when it is determined that the distance D has become equal to the second predetermined distance defined shorter than the first predetermined distance, the program proceeds to S26, in which a second bent arrow (right-turn arrow) of a length whose straight shaft portion is shorter than the aforesaid prescribed length of the first bent arrow, which indicates that the intersection to turn to right as suggested by the direction of bent is now closer, is displayed on the auxiliary display 32. When the result in S24 is NO, S26 is skipped.

Next, in S28, it is determined whether the designated destination has been reached. When the result in S28 is NO, the program returns to S14, and when it is YES, the program is terminated.

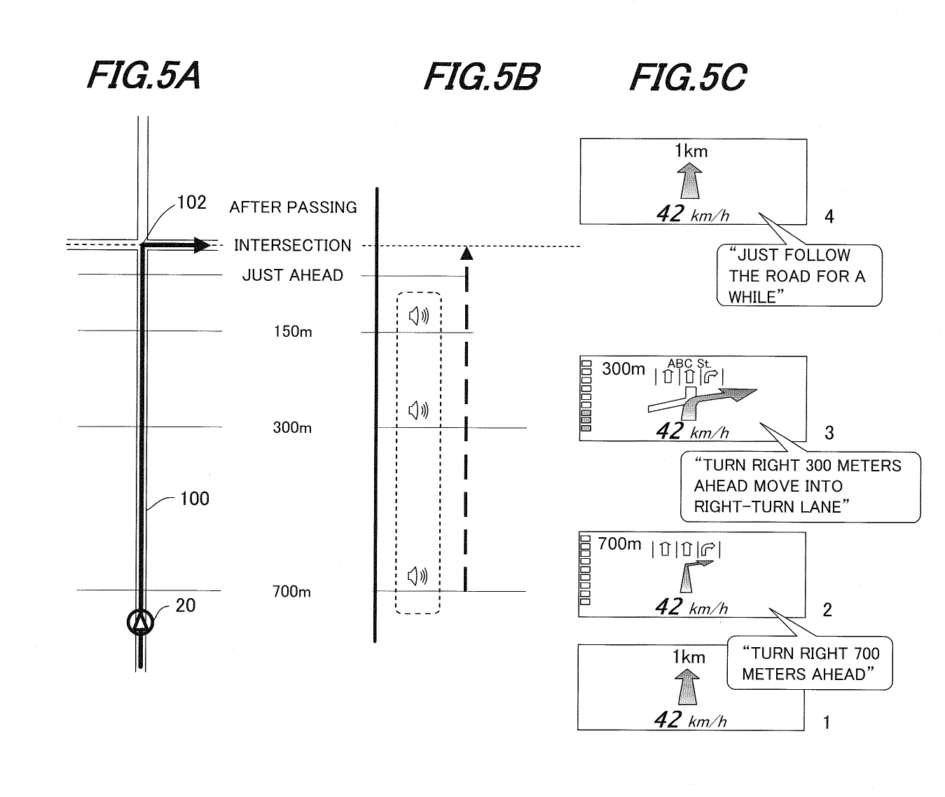

FIG. 5 is a set of explanatory views for explaining the foregoing processing. FIG. 5A shows a road 100 and intersection 102 on the route being traveled by vehicle 20, 5B shows the voice guidance provided through the speaker 16 as the vehicle 20 approaches the intersection 102, and FIG. 5C shows the screens (images) displayed on the auxiliary display 32.

By “intersection where the vehicle 20 is to turn” as termed in this specification is meant a routing path intersection, such as a crossroads, T-junction, or branching junction (three-forked, five-forked or other multiforked junction), at which the vehicle 20 is guided to proceed not straight ahead but, for example, to turn right, left or onto a branch.

The processing of FIG. 4 will be explained with reference to FIG. 5. Prior to the distance D from the vehicle 20 (its current location) to the intersection 102 becoming 700 meters, no voice guidance is given through the speaker 16 and guidance is limited to display of Screen 1 shown in FIG. 5C. Screen 1 includes the straight arrow, plus the vehicle speed (e.g., 42 km/h) and the distance D (e.g., 1 kilometer).

When the distance D becomes 700 meters (first predetermined value), the fact that the intersection 102 is 700 meters away is indicated by displaying the first bent arrow, whose straight shaft portion is of the prescribed length and extended overall as seen in Screen 2 of FIG. 5C, and voice guidance to the effect of “Turn right 700 meters ahead” is announced through the speaker 16. Screen 2 includes lane information in addition to the earlier displayed information. Note that the first bent arrow comprises an arrow which is bent in a direction in which the vehicle 20 is to turn at the intersection 102 and whose length from a bent starting portion to a point is shorter than that of the straight shaft portion. The width of the straight shaft portion is made narrower toward the bent starting portion.

Then, when the distance D becomes 300 meters (second predetermined value), the fact that the intersection 102 is now closer is indicated by displaying the second bent arrow, whose straight shaft portion is, as seen in Screen 3 of FIG. 5C, of a length shorter than the prescribed length of the first bent arrow shown in Screen 2, and voice guidance to the effect of “Turn right 300 meters ahead—Move into right-turn lane” is announced through the speaker 16. Screen 3 includes the name of the intersection in addition to the earlier displayed information. Note that the second bent arrow comprises an arrow which is bent in a direction in which the vehicle 20 is to turn at the intersection 102 and whose length from a bent starting portion to a point is longer than that of the straight shaft portion.

Next, when the distance D becomes 150 meters, voice guidance to the effect of “Turn is just ahead” is announced through the speaker 16 as indicated in FIG. 5B.

If after the vehicle 20 passes through the intersection 102 the distance to the next intersection where the vehicle 20 is to turn (not shown) is greater than the first predetermined distance, a straight arrow (straight third arrow) like that shown in Screen 4 is displayed as explained regarding S18 in FIG. 4, and voice guidance to the effect of “Just follow the road for a while” is announced. The width of the straight third arrow is made narrower toward a point thereof.

As explained, display of the straight arrow (third arrow) on the auxiliary display 32 is continued until the distance D becomes 700 meters (first predetermined distance). Instead, however, when another mode (fuel efficiency display mode, for example) is in effect, it is possible to discontinue the arrow display after passage of a suitable time (e.g., 5 seconds) or after traveling a suitable distance (e.g., 30 meters).

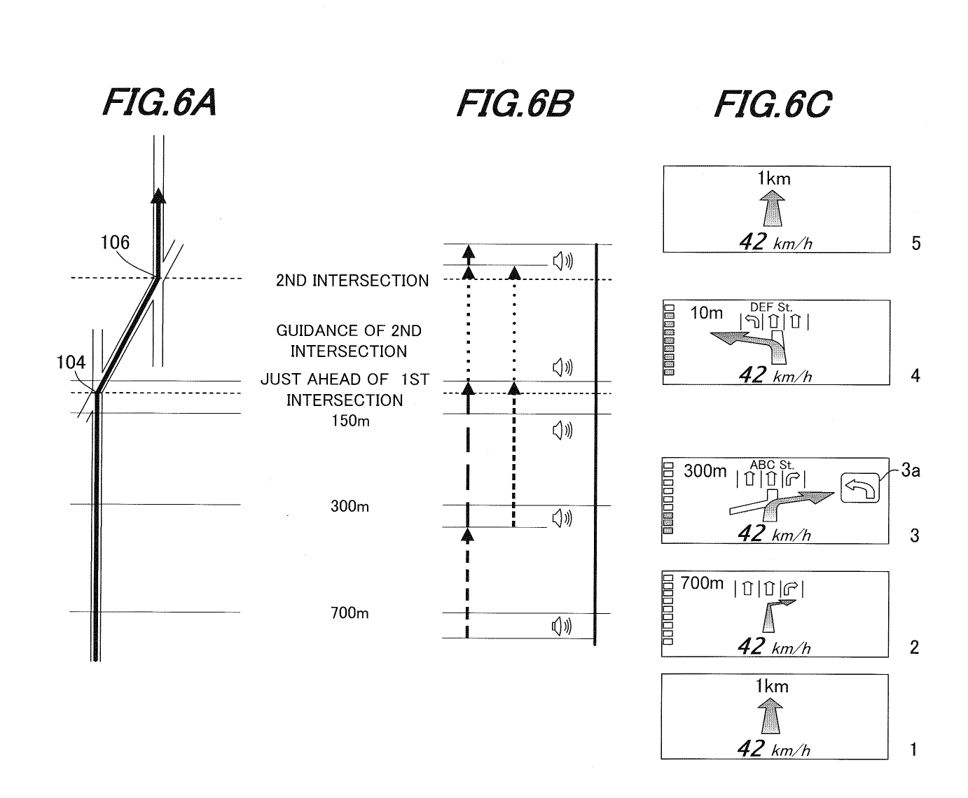

Similarly to FIG. 5, FIG. 6 is also a set of explanatory views for explaining the processing of FIG. 4. But differently from FIG. 5, FIG. 6 gives an example of a driving situation in which the routing path passes in succession through a first intersection 104 where the vehicle 20 is to turn right and a second intersection 106 where it is to turn left.

The processing of FIG. 4 will be explained with reference to FIG. 6. Similarly to in the case of FIG. 5, prior to the distance D from the vehicle 20 (its current location) to the first intersection 104 becoming 700 meters, no voice guidance is given through the speaker 16 and guidance is limited to display of Screen 1 shown in FIG. 6C.

When the distance D becomes 700 meters, the fact that the first intersection 104 is 700 meters ahead is indicated by displaying the first bent arrow of the prescribed length as seen in Screen 2 of FIG. 6C, and voice guidance to the effect of “Turn right 700 meters ahead” is announced through the speaker 16.

Then, when the distance D becomes 300 meters, the fact that the intersection 104 is now closer is indicated by displaying the second bent arrow, whose straight shaft portion is, as seen in Screen 3 of FIG. 6C, of a length shorter than the prescribed length shown in Screen 2, and voice guidance to the effect of “Turn right 300 meters ahead—Move into right-turn lane” is announced through the speaker 16.

At this time, a left-turn arrow (fourth bent arrow) is displayed in Window 3a in one corner of Screen 3. This arrow is displayed to indicate that immediately after turning right at the first intersection 104, the vehicle 20 is to turn left at the second intersection 106.

Next, when the distance D becomes 150 meters, voice guidance to the effect of “Turn is just ahead” is announced through the speaker 16 as indicated in FIG. 6B.

After the vehicle 20 passes through the first intersection 104, an arrow (fifth bent arrow) indicating the need to turn left at the second intersection 106 that follows is displayed, and voice guidance to the effect of “Turn left 300 meters ahead—Move into left-turn lane” is announced through the speaker 16. When the distance between the two successive intersections is shorter than 300 meters, it is possible instead to give the voice guidance, “Left turn shortly after.”

If after the vehicle 20 passes through the second intersection 106 the distance to the next intersection where the vehicle 20 is to turn (not shown) is greater than the first predetermined distance, a straight arrow (straight third arrow) like that shown in Screen 5 is displayed as explained regarding S18 in FIG. 4, and voice guidance to the effect of “Just follow the road for a while” is announced.

In the navigation apparatus 10 according to this embodiment, the first predetermined distance (e.g., 700 meters) and second predetermined distance (e.g., 300 meters) in the sequence of operations shown in FIGS. 4 to 6 can be varied with the traveling (vehicle) speed of the vehicle 20, i.e., in response to the output of the vehicle speed sensor 22b.

By way of example, the first and second predetermined distances would be defined to the foregoing 700 meters and 300 meters for a certain reference vehicle speed (e.g., 60 km/h) and be lengthened and shortened in proportion as the vehicle speed rises above and falls below the reference speed.

As stated in the foregoing, this embodiment is configured to have a navigation apparatus and method (10) of a vehicle (20), comprising: a current location detector (current location detection unit) (22, S10) that detects a current location of the vehicle; a routing path calculator (routing path calculating unit) (26, S12) that calculates a routing path from the current location to a designated destination; a monitor (14) adapted to display the calculated routing path on a map; an auxiliary display (32) that is installed independently of the monitor and positioned closer than the monitor to a lower edge (20b1) of a windshield (20b) of the vehicle (20); a distance calculator (distance calculating unit) (34, S14) that calculates a distance D along the routing path from the current location to an intersection (102, 104) in a direction of the designated destination at which the vehicle is to turn; and an auxiliary display operator (auxiliary display operating unit) (36, S16-S26) that operates the auxiliary display to display a first bent arrow of prescribed length which indicates that the intersection is a first predetermined distance away from the current location when the calculated distance has become equal to the first predetermined distance, and a second bent arrow of a length that is shorter than the prescribed length which indicates that the intersection approaches closer when the distance has become equal to a second predetermined distance that is defined shorter than the first predetermined distance.

With this, it becomes possible to display the intersections 102, 104 simply and in stages such that the driver can certainly recognize the intersections 102, 104 even when the driver cannot spare the time to view the road map on the monitor 14.

Further, since the auxiliary display operator operates the auxiliary display to display the first bent arrow of prescribed length which indicates that the intersection 102, 104 is a first predetermined distance away from the current location when the calculated distance D has become equal to the first predetermined distance, and the second bent arrow of a length that is shorter than the prescribed length which indicates that the intersection 102, 104 approaches closer when the distance D has become equal to the second predetermined distance that is defined shorter than the first predetermined distance, when the lane change or the like is needed, the driver can prepare for it early so as to, for example, avoid driving the vehicle 20 to turn before a target intersection by mistake. Thus, it becomes possible to surely guide the driver.

Further, since the auxiliary display 32 is installed independently of the monitor and positioned closer than the monitor to the lower edge 20b1 of a windshield 20b of the vehicle 20, the driver can visually check the auxiliary display 32 further easily.

Further, in the apparatus and method, the auxiliary display operator (36) operates the auxiliary display (32) to display a straight third arrow indicating that the vehicle (20) should travel straight when a distance D to a next intersection (106) where the vehicle (20) is to turn is greater than the first predetermined distance, after the vehicle passes through the intersection (104) (S16, S18). With this, in addition to the foregoing effects, the driver can comprehend well the condition of the course of travel before and after each intersection (102, 104, 106).

Further, in the apparatus and method, the first predetermined distance and the second predetermined distance are varied with traveling speed of the vehicle (20). With this, in addition to the foregoing effects, it becomes possible to display the first arrow, etc., at the appropriate timing which is neither too early nor too late.

Further, in the apparatus and method, the auxiliary display operator (36) operates the auxiliary display to display a straight third arrow indicating that the vehicle should travel straight also when the calculated distance D is greater than the first predetermined distance (S16, S18).

Further, in the apparatus and method, the auxiliary display operator (36) operates the auxiliary display to display a fourth bent arrow (3a) which indicates that immediately after turning the intersection (104), the vehicle is to turn an intersection (106) in a direction opposite to that of the turning the intersection (104) (S24, S26).

Further, the apparatus and method further includes: a speaker (16) adapted to give voice guidance in combination with the displaying of the auxiliary display (32), and the auxiliary display (32) comprises a head-up display (HUD) that has a flat mirror and retractable concave mirror to project a virtual image onto the windshield (20b).

Further, in the apparatus and method, the first bent arrow comprises an arrow which is bent in a direction in which the vehicle is to turn at the intersection (102, 104) and whose length from a bent starting portion to a point is shorter than that of straight shaft portion.

Further, in the apparatus and method, width of the straight shaft portion is made narrower toward the bent starting portion.

Further, in the apparatus and method, the second bent arrow comprises an arrow which is bent in a direction in which the vehicle is to turn at the intersection (102, 104) and whose length from a bent starting portion to a point is longer than that of a straight shaft portion.

Further, in the apparatus and method, width of the straight third arrow is made narrower toward a point.

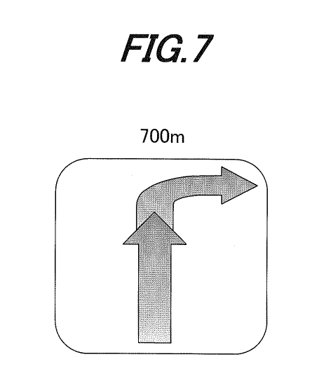

This invention is not limited to use of the first and other arrows shown as examples in FIGS. 5 and 6. It is possible instead, for instance, to replace the first arrow shown in Screen 2 of FIG. 5 with an arrow like that shown in FIG. 7.

The auxiliary display 32 can use flat and (retractable) concave mirrors to project the liquid crystal display (LCD) screen onto the windshield 20b as a virtual image or can be installed at some other location such as near the dashboard gauges 20c shown in FIG. 2.

Although it was explained that the auxiliary display operating unit 36 of the navigation apparatus 10 transmits codes representing the first to third arrows and other screen elements to the auxiliary display 32, it is possible instead for it to transmit video signals representing the first to third arrows and other screen elements.

Although the Screens 1 to 4 in FIGS. 5 and 6 include the vehicle 20 traveling speed, lane information and the distance D, these screen elements can be omitted.

Although it was explained that the display of guidance information on the screens and the announcement of voice guidance through the speaker 16 are linked and performed simultaneously, it is possible to perform them separately and state distances different from the first and second predetermined distances in the voice guidance through the speaker 16.

Japanese Patent Application No. 2008-300744 filed on Nov. 26, 2008, is incorporated by reference herein in its entirety.

While the invention has thus been shown and described with reference to specific embodiments, it should be noted that the invention is in no way limited to the details of the described arrangements; changes and modifications may be made without departing from the scope of the appended claims.

What is claimed is:

1. A navigation apparatus of a vehicle, comprising:
a current location detector that detects a current location of the vehicle;
a routing path calculator that calculates a routing path from the current location to a designated destination;
a monitor adapted to display the calculated routing path on a map;
an auxiliary display that is installed independently of the monitor and positioned closer than the monitor to a lower edge of a windshield of the vehicle;
a distance calculator that calculates a distance along the routing path from the current location to an intersection in a direction of the designated destination at which the vehicle is to turn; and
an auxiliary display operator that operates the auxiliary display to display a first bent arrow of prescribed length which indicates that the intersection is a first predetermined distance away from the current location when the calculated distance has become equal to the first predetermined distance, and a second bent arrow of a length that is shorter than the prescribed length which indicates that the intersection approaches closer when the distance has become equal to a second predetermined distance that is defined shorter than the first predetermined distance.

2. The apparatus according to claim 1, wherein the auxiliary display operator operates the auxiliary display to display a straight third arrow indicating that the vehicle should travel straight when a distance to a next intersection where the vehicle is to turn is greater than the first predetermined distance, after the vehicle passes through the intersection.

3. The apparatus according to claim 1, wherein the first predetermined distance and the second predetermined distance are varied with traveling speed of the vehicle.

4. The apparatus according to claim 1, wherein the auxiliary display operator operates the auxiliary display to display a straight third arrow indicating that the vehicle should travel straight when the calculated distance is greater than the first predetermined distance.

5. The apparatus according to claim 1, wherein the auxiliary display operator operates the auxiliary display to display a fourth bent arrow which indicates that immediately after turning the intersection, the vehicle is to turn an intersection in a direction opposite to that of the turning the intersection.

6. The apparatus according to claim 1, further including:
a speaker adapted to give voice guidance in combination with the displaying of the auxiliary display.

7. The apparatus according to claim 1, wherein the auxiliary display comprises a head-up display that has a flat mirror and retractable concave mirror to project a virtual image onto the windshield.

8. The apparatus according to claim 1, wherein the first bent arrow comprises an arrow which is bent in a direction in which the vehicle is to turn at the intersection and whose length from a bent starting portion to a point is shorter than that of straight shaft portion.

9. The apparatus according to claim 8, wherein width of the straight shaft portion is made narrower toward the bent starting portion.

10. The apparatus according to claim 1, wherein the second bent arrow comprises an arrow which is bent in a direction in which the vehicle is to turn at the intersection and whose length from a bent starting portion to a point is longer than that of a straight shaft portion.

11. The apparatus according to claim 2, wherein width of the straight third arrow is made narrower toward a point.

12. A navigation method of a vehicle having a monitor and an auxiliary display that is installed independently of the monitor and positioned closer than the monitor to a lower edge of a windshield of the vehicle, comprising the steps of:
detecting a current location of the vehicle;
calculating a routing path from the current location to a designated destination and displaying the calculated routing path on a map on the monitor;
calculating a distance along the routing path from the current location to an intersection in a direction of the designated destination at which the vehicle is to turn;
and
operating the auxiliary display to display a first bent arrow of prescribed length which indicates that the intersection is a first predetermined distance away from the current location when the calculated distance has become equal to the first predetermined distance, and a second bent arrow of a length that is shorter than the prescribed length which indicates that the intersection approaches closer when the distance has become equal to a second predetermined distance that is defined shorter than the first predetermined distance.

13. The method according to claim 12, wherein the step of auxiliary display operating operates the auxiliary display to display a straight third arrow indicating that the vehicle should travel straight when a distance to a next intersection where the vehicle is to turn is greater than the first predetermined distance, after the vehicle passes through the intersection.

14. The method according to claim 12, wherein the first predetermined distance and the second predetermined distance are varied with traveling speed of the vehicle.

15. The method according to claim 12, wherein the step of auxiliary display operating operates the auxiliary display to display a straight third arrow indicating that the vehicle should travel straight when the calculated distance is greater than the first predetermined distance.

16. The method according to claim 12, wherein the step of auxiliary display operating operates the auxiliary display to display a fourth bent arrow which indicates that immediately after turning the intersection, the vehicle is to turn in a direction opposite to that of the turning the intersection.

17. The method according to claim 12, further including step of:
operating a speaker adapted to give voice guidance in combination with the displaying of the auxiliary display.

18. The method according to claim 12, wherein the auxiliary display comprises a head-up display that has a flat mirror and retractable concave mirror to project a virtual image onto the windshield.

19. The method according to claim 12, wherein the first bent arrow comprises an arrow which is bent in a direction in which the vehicle is to turn at the intersection and whose length from a bent starting portion to a point is shorter than that of straight shaft portion.

20. The method according to claim 12, wherein the second bent arrow comprises an arrow which is bent in a direction in which the vehicle is to turn at the intersection and whose length from a bent starting portion to a point is longer than that of a straight shaft portion.
